(19) United States
(12) Patent Application Publication
(10) Pub. No.: US 2020/0166192 A1
(43) Pub. Date: May 28, 2020

(54) VEHICLE ILLUMINATION SYSTEM

(71) Applicant: KOITO MANUFACTURING CO., LTD., Tokyo (JP)

(72) Inventors: Atsushi Sugimoto, Shizuoka-shi (JP); Yoshiro Ito, Shizuoka-shi (JP); Tomoaki Harada, Shizuoka-shi (JP); Susumu Kaneko, Shizuoka-shi (JP); Hajime Takeda, Shizuoka-shi (JP)

(73) Assignee: KOITO MANUFACTURING CO., LTD., Tokyo (JP)

(21) Appl. No.: 16/694,341

(22) Filed: Nov. 25, 2019

(30) Foreign Application Priority Data
Nov. 26, 2018 (JP) 2018-220310

(51) Int. Cl. F21S 41/65; H05B 39/04; F21S 41/16

(52) U.S. Cl. CPC F21S 41/65; F21S 41/16; H05B 39/042

(57) ABSTRACT

A vehicle illumination system includes a road surface drawing lamp configured to draw, as a drawing on a road surface, predetermined information by emitting light toward a target comprising a ground, a wall or the like around a vehicle, an illuminance sensor capable of measuring an illuminance around the vehicle, and a lamp control unit configured to control the road surface drawing lamp. The lamp control unit is configured to control the road surface drawing lamp so that an illuminance of the drawing on the road surface is to be higher than the illuminance measured by the illuminance sensor.

### CROSS-REFERENCE TO RELATED APPLICATIONS

This application is based upon and claims the benefit of priority from prior Japanese patent application No. 2018-220310, filed on Nov. 26, 2018, the entire contents of which are incorporated herein by reference.

### TECHNICAL FIELD

The present disclosure relates to a vehicle illumination system.

### BACKGROUND ART

Currently, research on automatic driving technology of an automobile has been actively conducted in each country, and each country is considering the legislation so as to enable a vehicle (hereinafter, a “vehicle” refer to an automobile) to travel in an automatic driving mode on public roads. Here, in the automatic driving mode, a vehicle system automatically controls traveling of a vehicle. Specifically, in the automatic driving mode, the vehicle system automatically performs at least one of a steering control (control of a traveling direction of the vehicle), a brake control and an accelerator control (control of braking and acceleration/deceleration of the vehicle), based on information (surrounding environment information) indicative of a surrounding environment of the vehicle obtained from a camera and a sensor such as a radar (for example, a laser radar and a millimeter wave radar). On the other hand, in a manual driving mode to be described later, a driver controls the traveling of the vehicle, as in most of conventional vehicles. Specifically, in the manual driving mode, the traveling of the vehicle is controlled in conformity with a driver's operation (a steering operation, a braking operation, and an accelerator operation), and the vehicle system does not automatically perform the steering control, the brake control and the accelerator control. Meanwhile, the driving mode of the vehicle is not a concept existing only in some vehicles but a concept existing in all vehicles including conventional vehicles having no automatic driving function. For example, the driving mode of the vehicle is classified in accordance with a vehicle control method or the like.

Thus, in the future, it is expected that vehicles traveling in the automatic driving mode (hereinafter, appropriately referred to as “automatic driving vehicle”) and vehicles traveling in the manual driving mode (hereinafter, appropriately referred to as “manual driving vehicle”) coexist on public roads.

As an example of the automatic driving technology, JP-A-H09-277887 discloses an automatic follow-up traveling system in which a following vehicle can automatically follow a preceding vehicle. In the automatic follow-up traveling system, each of the preceding vehicle and the following vehicle has an illumination system, character information for preventing the other vehicle from intruding between the preceding vehicle and the following vehicle is displayed on the illumination system of the preceding vehicle, and character information indicative of the automatic follow-up traveling mode is displayed on the illumination system of the following vehicle.

### SUMMARY OF INVENTION

In the automatic driving society in which the automatic driving vehicle and the manual driving vehicle coexist, it is expected that the vehicle is mounted with a so-called road surface drawing lamp configured to visually present a pedestrian and the like with a variety of information (for example, information about the automatic driving mode of the vehicle) relating to the automatic driving by drawing the same. In this case, since the pedestrian can perceive the drawn information by visually recognizing the same, it is possible to reduce the pedestrian's anxiety about the automatic driving vehicle. In the meantime, a situation may occur in which when the road surface on which the information is to be drawn is bright, visibility of the drawn information is lowered.

It is therefore an object of the present disclosure to provide a vehicle illumination system capable of suppressing visibility of information drawn on a road surface from being lowered.

According to an embodiment of the present disclosure, there is provided a vehicle illumination system comprising:

a road surface drawing lamp configured to draw, as a drawing on a road surface, predetermined information by emitting light toward a target comprising a ground, a wall or the like around a vehicle;

an illuminance sensor capable of measuring an illuminance around the vehicle, and

a lamp control unit configured to control the road surface drawing lamp,

wherein the lamp control unit is configured to control the road surface drawing lamp so that an illuminance of the drawing on the road surface is to be higher than the illuminance measured by the illuminance sensor.

According to the vehicle illumination system configured as described above, the road surface drawing lamp emits light at an illuminance higher than an illuminance around the vehicle. For this reason, a pedestrian and the like can visually recognize the information drawn on the road surface.

According to the above configuration, it is possible to provide the vehicle illumination system capable of suppressing visibility of the information drawn on the road surface from being lowered.

According to an embodiment of the present disclosure, there is provided a vehicle illumination system comprising a wavelength specifying unit capable of specifying a wavelength distribution of light around the vehicle,

wherein the lamp control unit is configured to acquire an output of the wavelength specifying unit and to specify a low intensity wavelength in a wavelength band of the light, and

wherein the lamp control unit is configured to control the road surface drawing lamp to irradiate light of the low intensity wavelength.

According to an embodiment of the present disclosure, there is provided a vehicle illumination system comprising:

a road surface drawing lamp configured to draw, as a drawing on a road surface, predetermined information by emitting light toward a target comprising a ground, a wall or the like around a vehicle;

a wavelength specifying unit capable of specifying a wavelength distribution of light around the vehicle, and

a lamp control unit configured to control the road surface drawing lamp,

wherein the lamp control unit is configured to control the road surface drawing lamp to irradiate light of a low intensity wavelength of the wavelength distribution of the light specified by the wavelength specifying unit.

According to the vehicle illumination system configured as described above, the lamp control unit specifies the low intensity wavelength in the wavelength band of the light around the vehicle. The lamp control unit controls the road surface drawing lamp so that light of the low intensity wavelength is to be irradiated. For this reason, a pedestrian and the like can visually recognize the information drawn on the road surface.

According to the vehicle illumination system configured as described above, the illuminance sensor may be configured to measure an illuminance of a place in which the road surface is to be drawn.

According to the vehicle illumination system configured as described above, the road surface drawing lamp emits the light, depending on an illuminance of the place in which the road surface is to be drawn. For this reason, for example, when a surrounding area of the vehicle is bright and an illuminance of the place in which the road surface is to be drawn is low, the road surface drawing lamp can emit light so as to have an appropriate illuminance.

According to the vehicle illumination system configured as described above, the lamp control unit may be configured to control the road surface drawing lamp by using a filter configured to transmit light of a low intensity wavelength.

According to the vehicle illumination system configured as described above, it is possible to conveniently control the road surface drawing lamp to emit light of the low intensity wavelength in the wavelength band of the light around the vehicle by switching the transmission filter.

According to the present disclosure, it is possible to provide the vehicle illumination system capable of suppressing the visibility of the information drawn on the road surface from being lowered.

### BRIEF DESCRIPTION OF DRAWINGS

FIG. 1A is a plan view of a vehicle on which a vehicle illumination device in accordance with an exemplary embodiment of the present disclosure is mounted, and FIG. 1B is a left side view of the vehicle shown in FIG. 1A.

FIG. 2 is a block diagram of a vehicle system including the vehicle illumination device of the exemplary embodiment of the present disclosure.

FIG. 3 is a flowchart depicting processing of irradiating a light pattern toward a target.

FIG. 4 depicts a state in which a road surface drawing lamp irradiates the light pattern toward a pedestrian.

FIG. 5 is a flowchart depicting processing of irradiating a light pattern toward the target.

FIG. 6A depicts relative irradiances at respective wavelengths of light around the vehicle, FIG. 6B depicts relative irradiances at respective wavelengths of light emitted from the road surface drawing lamp, FIG. 6C depicts transmittances at respective wavelengths of the light emitted from the road surface drawing lamp, and FIG. 6D depicts relative irradiances at respective wavelengths of transmitted light.

FIG. 7 is a flowchart depicting processing of irradiating a light pattern toward the target.

### DETAILED DESCRIPTION OF EMBODIMENTS

Hereinbelow, an exemplary embodiment of the present disclosure (hereinbelow, referred to as the exemplary embodiment) will be described with reference to the drawings. Meanwhile, for the sake of convenience of descriptions, the description of members having the same reference numerals as those already described in the description of the exemplary embodiment will be omitted. Also, for the sake of convenience of description, dimensions of the respective members shown in the drawings may be different from actual dimensions of the respective members.

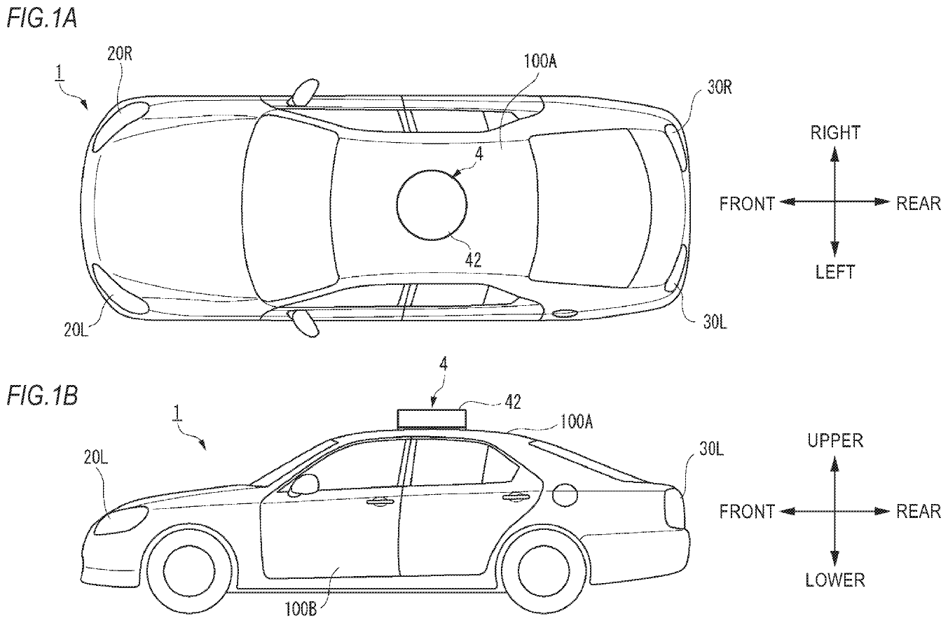

Also, in the description of the exemplary embodiment, for the sake of convenience of description, “the right and left direction”, “the front and rear direction” and “the upper and lower direction” will be appropriately mentioned. The directions are relative directions set with respect to a vehicle 1 shown in FIG. 1. Here, “the upper and lower direction” is a direction including “the upward direction” and “the downward direction”. “The front and rear direction” is a direction including “the forward direction” and “the rearward direction”. “The right and left direction” is a direction including “the rightward direction” and “the leftward direction”.

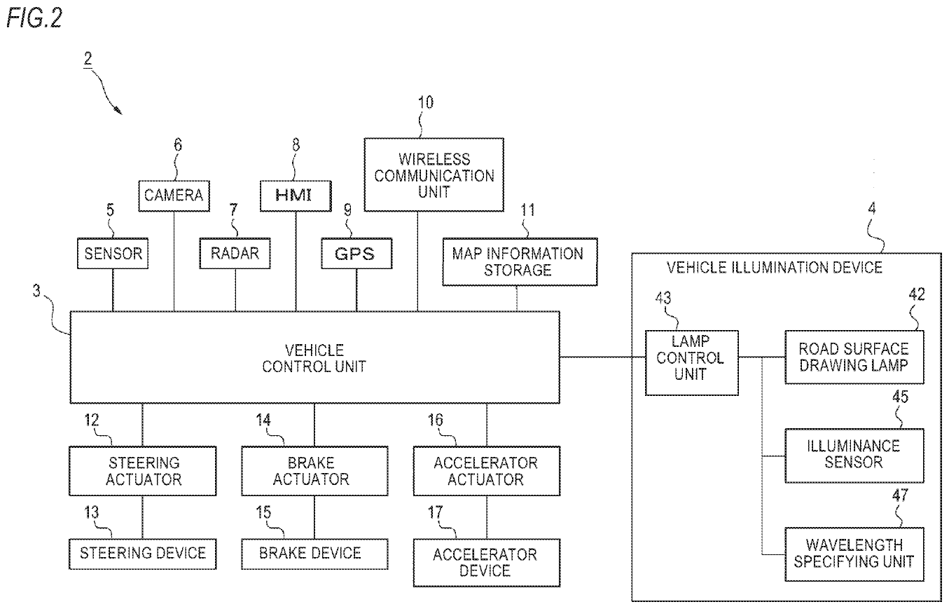

A vehicle illumination device 4 of the exemplary embodiment (hereinbelow, simply referred to as “illumination device 4”) is described. FIG. 1A is a front view of a vehicle 1, and FIG. 1B is a left side view of the vehicle 1. The vehicle 1 is a vehicle capable of traveling in an automatic driving mode, and includes the illumination device 4. The illumination device 4 includes a road surface drawing lamp 42, a lamp control unit 43, an illuminance sensor 45, and a wavelength specifying unit 47 (refer to FIG. 2). The road surface drawing lamp 42 is arranged on a vehicle body roof 100A of the vehicle 1, and is configured to irradiate light toward an outside of the vehicle 1.

The road surface drawing lamp 42 is a laser scanning device including a laser light source and a light deflection device configured to deflect laser light emitted from the laser light source, for example. The light deflection device is a movable mirror such as a MEMS (Micro Electro Mechanical Systems) mirror, a galvano-mirror and the like. The road surface drawing lamp 42 is configured to scan the laser light, thereby drawing a light pattern on a road surface around a target, as described later.

Meanwhile, in the exemplary embodiment, the single road surface drawing lamp 42 is arranged on the vehicle body roof 100A. However, the number, arrangement, shape and the like of the road surface drawing lamp 42 are not particularly limited, inasmuch as the road surface drawing lamp 42 can irradiate a light pattern toward the target existing in any direction on the basis of the vehicle 1. For example, two road surface drawing lamps 42 of four road surface drawing lamps 42 may be respectively arranged in a left headlamp 20L and a right headlamp 20R, and the two remaining road surface drawing lamps 42 may be respectively arranged in a left rear combination lamp 30L and a right rear combination lamp 30R. Also, the road surface drawing lamp 42 may be arranged to surround a side surface 100B of the vehicle 1.

Subsequently, a vehicle system 2 of the vehicle 1 is described with reference to FIG. 2. FIG. 2 is a block diagram of the vehicle system 2. As shown in FIG. 2, the vehicle system 2 includes a vehicle control unit 3, an illumination device 4, a sensor 5, a camera 6, a radar 7, an HMI (Human Machine Interface) 8, a GPS (Global Positioning System) 9, a wireless communication unit 10, and a map information storage 11. In addition, the vehicle system 2 includes a steering actuator 12, a steering device 13, a brake actuator 14, a brake device 15, an accelerator actuator 16, and an accelerator device 17.

The vehicle control unit 3 is configured to control traveling of the vehicle 1. The vehicle control unit 3 is configured by an electronic control unit (ECU). The electronic control unit is configured by a processor such as a CPU (Central Processing Unit), a ROM (Read Only Memory) in which diverse vehicle control programs are stored, and a RAM (Random Access Memory) in which a variety of vehicle control data is temporarily stored. The processor is configured to develop, on the RAM, a program designated from the diverse vehicle control programs stored in the ROM and to execute a variety of processing in cooperation with the RAM.

The sensor 5 includes an acceleration sensor, a speed sensor, a gyro sensor, and the like. The sensor 5 is configured to detect a traveling condition of the vehicle 1 and to output traveling condition information indicative of the traveling condition of the vehicle 1 to the vehicle control unit 3. The sensor 5 may further include a seating sensor configured to detect whether a driver is sitting on a driver seat, a face direction sensor configured to detect a direction of a driver's face, an external weather sensor configured to detect an external weather condition, a passenger detection sensor configured to detect whether there is a passenger in a vehicle, and the like.

The camera 6 is, for example, a camera including an imaging device such as a CCD (Charge-Coupled Device) and a CMOS (complementary MOS). The radar 7 is a millimeter wave radar, a microwave radar, a laser radar, or the like. The camera 6 and/or the radar 7 is configured to detect surrounding environments (other vehicles, pedestrians, road shapes, traffic signs, obstacles, and the like) of the vehicle 1 and to output the surrounding environment information to the vehicle control unit 3.

The HMI 8 includes an input unit configured to receive an input operation from a driver and an output unit configured to output the traveling information and the like toward the driver. The input unit includes a steering wheel, an accelerator pedal, a brake pedal, a driving mode changeover switch for switching the driving mode of the vehicle 1, and the like. The output unit is a display configured to display the diverse traveling information

The GPS 9 is configured to acquire current position information of the vehicle 1 and to output the acquired current position information to the vehicle control unit 3. The wireless communication unit 10 is configured to receive information (for example, traveling information, and the like) relating to other vehicles around the vehicle 1 from the other vehicles and to transmit information (for example, traveling information, and the like) relating to the vehicle 1 to the other vehicles (inter-vehicle communication). Also, the wireless communication unit 10 is configured to receive infrastructure information from infrastructure equipment such as a traffic light, a marker lamp and the like and to transmit the traveling information of the vehicle 1 to the infrastructure equipment (road-to-vehicle communication). The vehicle 1 may be configured to perform communication with the other vehicles and the infrastructure equipment directly or via a wireless communication network. The map information storage 11 is an external storage device such as a hard disk drive in which map information is stored, and is configured to output the map information to the vehicle control unit 3.

The illumination device 4 is configured to irradiate the laser light (particularly, a ring-shaped or line-shaped light pattern) toward an outside of the vehicle 1 (particularly, a target such as a road surface, a wall and the like around the vehicle 1). The illumination device 4 includes the road surface drawing lamp 42, the lamp control unit 43, the illuminance sensor 45, and the wavelength specifying unit 47. The lamp control unit 43 is configured by an electronic control unit (ECU). The lamp control unit 43 is configured to control the road surface drawing lamp 42 to irradiate the laser light toward the target, based on position information of the target. In the meantime, the lamp control unit 43 and the vehicle control unit 3 may be configured by the same electronic control unit. The illuminance sensor 45 is configured to detect an illuminance around the vehicle 1. The illuminance sensor 45 is a sensor for which a photo transistor is used, a sensor for which a photo diode is used, a sensor in which an amplification circuit is added to a photo diode, and the like, for example. The illuminance information detected by the illuminance sensor 45 is transmitted to the lamp control unit 43. The lamp control unit 43 is configured to control the road surface drawing lamp 42 to irradiate the laser light at an illuminance higher than an illuminance around the vehicle 1, based on the illuminance information detected by the illuminance sensor 45. The wavelength specifying unit 47 includes an optical sensor and a spectrometer. As the optical sensor, for example, an avalanche photo diode, a photo diode and the like may be used. The wavelength specifying unit 47 is configured to sense the light around the vehicle 1 by the optical sensor. The wavelength specifying unit 47 is configured to generate spectrum data, which indicates a spectrum waveform of the sensed light, from the sensed light. Also, the wavelength specifying unit 47 is configured to transmit the spectrum data to the lamp control unit 43. The lamp control unit 43 is configured to specify a low intensity wavelength band, based on the spectrum data.

When the vehicle 1 travels in an automatic driving mode, the vehicle control unit 3 automatically generates at least one of a steering control signal, an accelerator control signal and a brake control signal, based on the traveling condition information, the surrounding environment information, the current position information, the map information and the like. The steering actuator 12 is configured to receive the steering control signal from the vehicle control unit 3 and to control the steering device 13 on the basis of the received steering control signal. The brake actuator 14 is configured to receive the brake control signal from the vehicle control unit 3 and to control the brake device 15 on the basis of the received brake control signal. The accelerator actuator 16 is configured to receive the accelerator control signal from the vehicle control unit 3 and to control the accelerator device 17 on the basis of the received accelerator control signal. In this way, in the automatic driving mode, the traveling of the vehicle 1 is automatically controlled by the vehicle system 2.

On the other hand, when the vehicle 1 travels in a manual driving mode, the vehicle control unit 3 generates a steering control signal, an accelerator control signal and a brake control signal in conformity with a driver's manual operation on the accelerator pedal, the brake pedal and the steering wheel. In this way, in the manual driving mode, the steering control signal, the accelerator control signal and the brake control signal are generated by the driver's manual operation, so that the traveling of the vehicle 1 is controlled by the driver.

Subsequently, the driving mode of the vehicle 1 is described. The driving mode includes an automatic driving mode and a manual driving mode. The automatic driving mode includes a full-automatic driving mode, an advanced driving support mode, and a driving support mode. In the full-automatic driving mode, the vehicle system 2 is configured to automatically perform all of the traveling controls of the steering control, the brake control and the accelerator control, and the driver is not in a state where it is possible to drive the vehicle 1. In the advanced driving support mode, the vehicle system 2 is configured to automatically perform all of the traveling controls of the steering control, the brake control and the accelerator control, and the driver does not drive the vehicle 1 although the driver is in a state where it is possible to drive the vehicle 1. In the driving support mode, the vehicle system 2 is configured to automatically perform a part of the traveling controls of the steering control, the brake control and the accelerator control, and the driver drives the vehicle 1 under the driving support of the vehicle system 2. On the other hand, in the manual driving mode, the vehicle system 2 is configured not to automatically perform the traveling controls, and the driver drives the vehicle 1 without the driving support of the vehicle system 2.

Also, the driving mode of the vehicle 1 may be switched by operating a driving mode changeover switch. In this case, the vehicle control unit 3 is configured to switch the driving mode of the vehicle 1 among the four driving modes (the full-automatic driving mode, the advanced driving support mode, the driving support mode, and the manual driving mode) in accordance with a driver's operation on the driving mode changeover switch. Also, the driving mode of the vehicle 1 may be automatically switched on the basis of information relating to a travel-allowed section where traveling of an automatic driving vehicle is allowed or a travel-prohibited section where the traveling of the automatic driving vehicle is prohibited or information relating to the external weather condition. In this case, the vehicle control unit 3 is configured to switch the driving mode of the vehicle 1, based on such information. Also, the driving mode of the vehicle 1 may be automatically switched by using a seating sensor, a face direction sensor, or the like. In this case, the vehicle control unit 3 may be configured to switch the driving mode of the vehicle 1, based on an output signal from the seating sensor or the face direction sensor.

### First Exemplary Embodiment

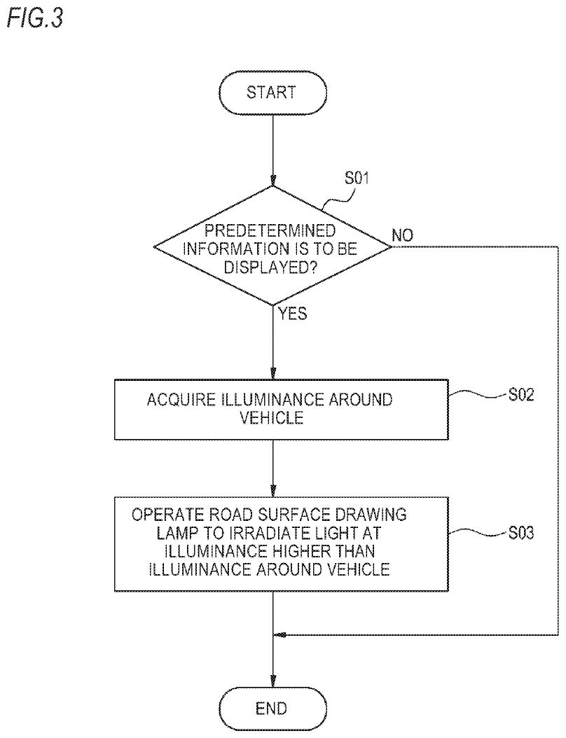

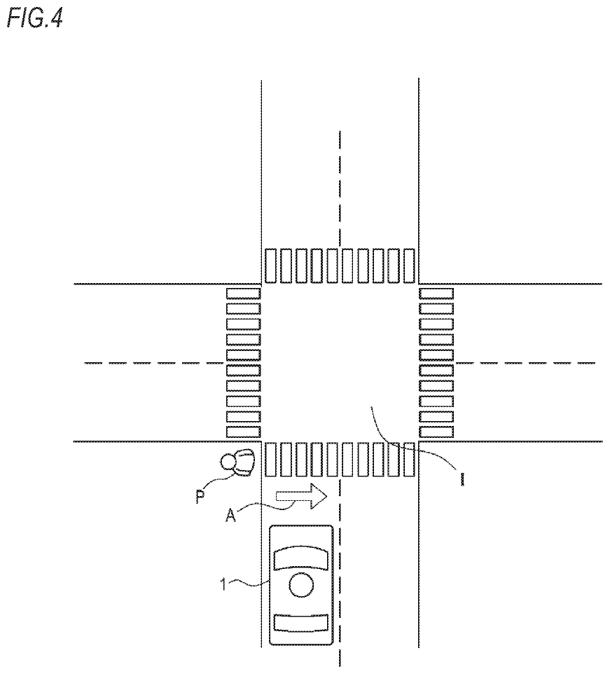

Subsequently, processing of irradiating a light pattern toward a target in accordance with a first exemplary embodiment is described with reference to FIGS. 3 and 4. FIG. 3 is a flowchart depicting processing of irradiating a light pattern toward a target. FIG. 4 depicts a state in which the road surface drawing lamp 42 irradiates a light pattern toward a pedestrian P. In the meantime, the pedestrian P is a target having received predetermined information from the vehicle 1.

As shown in FIG. 3, first, the vehicle control unit 3 determines whether it is necessary to display predetermined information (for example, information about a traveling path of the vehicle 1) on the road surface around the vehicle 1 (step S01). In FIG. 4, the vehicle control unit 3 intends to turn right the vehicle 1. At this time, the vehicle control unit 3 determines that it is necessary to display information, which indicates the vehicle 1 is to turn right at an intersection I, on the road surface ahead of the vehicle 1. In the example of FIG. 4, the vehicle control unit 3 displays an arrow A of which a tip faces rightward on the road surface around the vehicle 1. On the other hand, when it is determined that it is not necessary to display the predetermined information on the road surface around the vehicle 1 (step S01: NO), the vehicle control unit 3 ends the processing.

When it is determined that it is necessary to display the predetermined information on the road surface around the vehicle 1 (step S01: YES), the vehicle control unit 3 generates an instruction signal for acquiring illuminance information about an illuminance around the vehicle 1. The vehicle control unit 3 transmits the instruction signal to the lamp control unit 43. The lamp control unit 43 controls the illuminance sensor 45 to detect an illuminance around the vehicle 1, based on the instruction signal. The illuminance sensor 45 measures an illuminance around the vehicle 1 (step S02).

The illuminance sensor 45 measures an illuminance of a place in which the road surface is to be drawn. The place in which the road surface is to be drawn is preferably a place ahead of the vehicle 1 or close to the pedestrian P. The camera 6 captures a surrounding area of the vehicle 1. The surrounding area of the vehicle 1 includes the place in which the road surface is to be drawn. When the camera 6 captures a surrounding area of the vehicle 1, the camera 6 generates captured data. The captured data is transmitted to the vehicle control unit 3. The vehicle control unit 3 generates an instruction signal for instructing the illuminance sensor 45 to measure an illuminance of the place in which the road surface is to be drawn, based on the captured data, and transmits the instruction signal to the lamp control unit 43. The lamp control unit 43 controls the illuminance sensor 45, based on the instruction signal. The illuminance sensor 45 transmits illuminance information about the measured illuminance to the lamp control unit 43.

The lamp control unit 43 operates the road surface drawing lamp 42 to irradiate the laser light at an illuminance higher than the illuminance around the vehicle 1, based on the illuminance information (step S03). In the first exemplary embodiment, the road surface drawing lamp 42 draws the arrow A on the road surface ahead of the vehicle 1, as shown in FIG. 4. Since the arrow A is drawn by the laser light having an illuminance higher than the illuminance around the vehicle 1, the pedestrian P can visually recognize the arrow A.

According to the configuration of the first exemplary embodiment, the lamp control unit 43 controls the light that is to be emitted from the road surface drawing lamp 42, depending on the illuminance around the vehicle 1. For this reason, the road surface drawing lamp 42 emits the light at an illuminance higher than the illuminance around the vehicle. As a result, even when the surrounding area of the vehicle 1 is bright, the pedestrian P can visually recognize the information drawn on the road surface.

According to the configuration of the first exemplary embodiment, the road surface drawing lamp 42 emits the light, depending on the illuminance of the place in which the road surface is to be drawn. For this reason, for example, when an illuminance around the vehicle 1 is high and an illuminance of the place in which the road surface is to be drawn is low, the road surface drawing lamp 42 can emit the light so as to have an appropriate illuminance.

### Second Exemplary Embodiment

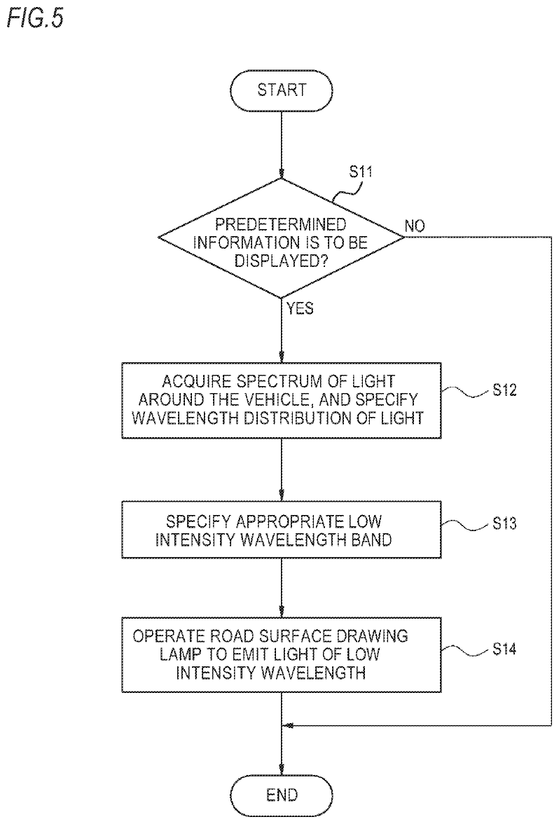

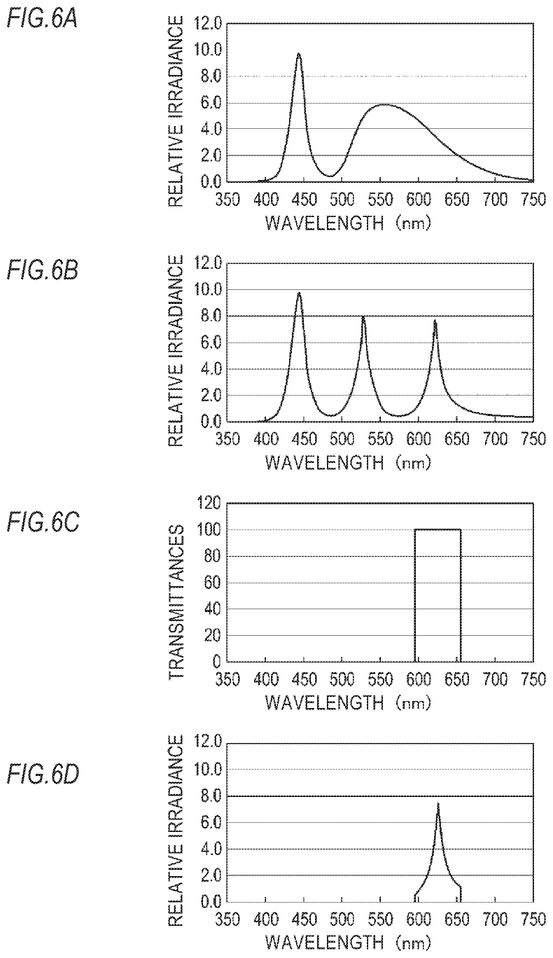

Subsequently, processing of irradiating a light pattern toward a target in accordance with a second exemplary embodiment is described with reference to FIGS. 5 and 6. FIG. 5 is a flowchart depicting processing of irradiating a light pattern toward a target. FIG. 6A depicts relative irradiances at respective wavelengths of light around the vehicle, FIG. 6B depicts relative irradiances at respective wavelengths of light emitted from the road surface drawing lamp, FIG. 6C depicts transmittances at respective wavelengths of the light emitted from the road surface drawing lamp, and FIG. 6D depicts relative irradiances at respective wavelengths of transmitted light. In the meantime, the processing of the second exemplary embodiment that is to be executed until a light pattern is displayed partially overlaps the processing of the first exemplary embodiment. Therefore, the descriptions of the overlapping processing are omitted.

Since step S11 is similar to step S01, the description thereof is omitted. The wavelength specifying unit 47 senses the light around the vehicle 1. The wavelength specifying unit 47 acquires a spectrum of the sensed light, from the sensed light, and specifies a wavelength distribution of the light around the vehicle 1 (step S12). The wavelength specifying unit 47 transmits information about the spectrum to the lamp control unit 43.

FIG. 6A depicts the spectrum of the light around the vehicle 1. As shown in FIG. 6A, in the light around the vehicle 1, a wavelength band of 430 nm or shorter, a wavelength band of 460 nm to 520 nm and a wavelength band of 615 nm to 750 nm are low intensity wavelength bands. In the meantime, as shown in FIG. 6B, the emission light of the road surface drawing lamp 42 has high illuminances in a first wavelength band (wavelength band of 410m to 470 nm) including a wavelength band of 430 nm to 450 nm, a second wavelength band (wavelength band of 505 nm to 555 nm) including a wavelength band of 515 nm to 535 nm and a third wavelength band (wavelength band of 595 nm to 655 nm) including a wavelength band of 615 nm to 635 nm. For example, the road surface drawing lamp 42 of the exemplary embodiment includes a first light-emitting element configured to emit light of the first wavelength band, a second light-emitting element configured to emit light of the second wavelength band, and a third light-emitting element configured to emit light of the third wavelength band. In the meantime, each light-emitting element may include a predetermined fluorescent material. The lamp control unit 43 specifies an appropriate low intensity wavelength band, based on the spectrum information received from the wavelength specifying unit 47 and the spectrum information of the emission light of the road surface drawing lamp 42 (step S13). In the second exemplary embodiment, the wavelength band of 615 nm to 635 nm is an appropriate low intensity wavelength band of the light around the vehicle 1. The lamp control unit 43 controls the road surface drawing lamp 42 to emit light of the third wavelength band (step S14). That is, the lamp control unit 43 controls the road surface drawing lamp 42 to emit light from the third light-emitting element. For this reason, the arrow A is drawn by light having a low intensity wavelength of the light around the vehicle 1 and having a high intensity wavelength of the emission light of the road surface drawing lamp 42. As a result, the pedestrian P can visually recognize the arrow A.

Also, the lamp control unit 43 can transmit only light of a specific wavelength by using a transmission filter, in step S14. In the second exemplary embodiment, the lamp control unit 43 transmits only light of a wavelength included in the appropriate low intensity wavelength band specified by the lamp control unit 43. For this reason, as shown in FIG. 6C, light of a wavelength included in the wavelength band of 595 nm to 655 nm is transmitted and light of the other wavelengths is not transmitted. In the meantime, the spectrum of the transmitted light is as shown in FIG. 6D.

According to the configuration of the second exemplary embodiment, the light having a low intensity wavelength of the light around the vehicle 1 and having a high illuminance wavelength of the emission light of the road surface drawing lamp 42 is emitted from the road surface drawing lamp 42. For this reason, the pedestrian P can visually recognize the information drawn on the road surface.

Also, according to the configuration of the second exemplary embodiment, the lamp control unit 43 can control the road surface drawing lamp 42 by switching the transmission filter, without adjusting the wavelength of the light to be emitted from the light-emitting element. For this reason, it is possible to conveniently emit the light having a wavelength to be irradiated, from the road surface drawing lamp 42.

Meanwhile, in the second exemplary embodiment, the vehicle illumination device 4 may not include the illuminance sensor 45.

### Third Exemplary Embodiment

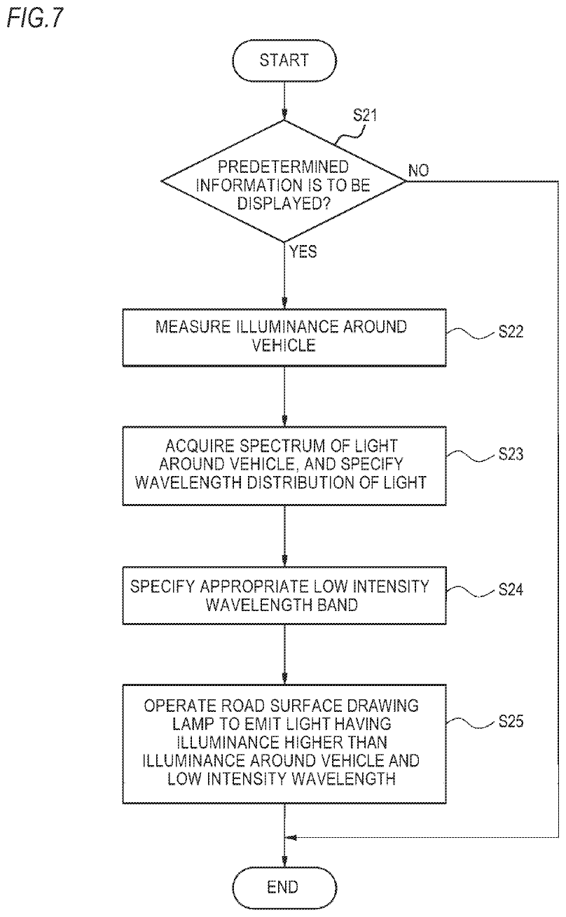

Subsequently, processing of irradiating a light pattern toward a target in accordance with a third exemplary embodiment is described with reference to FIG. 7. FIG. 7 is a flowchart depicting processing of irradiating a light pattern toward a target. In the meantime, the processing of the third exemplary embodiment that is to be executed until a light pattern is displayed partially overlaps the processing of the first exemplary embodiment or the processing of the second exemplary embodiment. Therefore, the descriptions of the overlapping processing are omitted.

Since step S21 is similar to steps S01 and S11, the description thereof is omitted. Since step S22 is similar to step S02, the description thereof is omitted. Since steps S23 to S24 are similar to steps S12 to S13, the descriptions thereof are omitted.

Then, the lamp control unit 43 operates the road surface drawing lamp 42 to emit light having an illuminance higher than an illuminance around the vehicle 1 and a wavelength included in an appropriate low intensity wavelength band, based on the illuminance information around the vehicle 1 (step S25). For this reason, since the arrow A is drawn by light having an illuminance higher than an illuminance around the vehicle 1 and a low intensity wavelength of the light around the vehicle 1, the pedestrian P can visually recognize the arrow A.

According to the configuration of the third exemplary embodiment, the road surface drawing lamp 42 emits the light included in the appropriate wavelength band, at an appropriate illuminance. For this reason, the pedestrian P can visually recognize the information drawn on the road surface.

According to the configuration of the third exemplary embodiment, like the first exemplary embodiment, for example, when the illuminance around the vehicle 1 is high and the illuminance of the place in which the road surface is to be drawn is low, the road surface drawing lamp 42 can emit the light so as to have an appropriate illuminance.

In the respective exemplary embodiments, the illuminance sensor 45 is configured to detect the illuminance around the vehicle 1. However, the present disclosure is not limited thereto. That is, the illuminance sensor 45 may not be provided in the vehicle illumination device 4. In this case, the sensor 5 or the camera 6 has the function of the illuminance sensor.

In the meantime, the present disclosure is not limited to the exemplary embodiments and can be appropriately modified and improved. In addition, the materials, shapes, dimensions, numerical values, forms, numbers, arrangement places and the like of the respective constitutional elements of the exemplary embodiments are arbitrary and are not particularly limited inasmuch as the present disclosure can be implemented.

What is claimed is:

1. A vehicle illumination system comprising:
a road surface drawing lamp configured to draw, as a drawing on a road surface, predetermined information by emitting light toward a target comprising a ground, a wall or the like around a vehicle;
an illuminance sensor capable of measuring an illuminance around the vehicle, and
a lamp control unit configured to control the road surface drawing lamp,
wherein the lamp control unit is configured to control the road surface drawing lamp so that an illuminance of the drawing on the road surface is to be higher than the illuminance measured by the illuminance sensor.

2. The vehicle illumination system according to claim 1, further comprising a wavelength specifying unit capable of specifying a wavelength distribution of light around the vehicle,
wherein the lamp control unit is configured to acquire an output of the wavelength specifying unit and to specify a low intensity wavelength in a wavelength band of the light, and
wherein the lamp control unit is configured to control the road surface drawing lamp to irradiate light of the low intensity wavelength.

3. A vehicle illumination system comprising:
a road surface drawing lamp configured to draw, as a drawing on a road surface, predetermined information by emitting light toward a target comprising a ground, a wall or the like around a vehicle;
a wavelength specifying unit capable of specifying a wavelength distribution of light around the vehicle, and
a lamp control unit configured to control the road surface drawing lamp,
wherein the lamp control unit is configured to control the road surface drawing lamp to irradiate light of a low intensity wavelength of the wavelength distribution of the light specified by the wavelength specifying unit.

4. The vehicle illumination system according to claim 1, wherein the illuminance sensor is configured to measure an illuminance of a place in which the road surface is to be drawn.

5. The vehicle illumination system according to claim 1, wherein the lamp control unit is configured to control the road surface drawing lamp by using a filter configured to transmit light of a low intensity wavelength.
